(19) United States
(12) Patent Application Publication
(10) Pub. No.: US 2012/0244987 A1
(43) Pub. Date: Sep. 27, 2012

(54) LOCKING DIFFERENTIAL ASSEMBLY

(75) Inventor: Bryan Haugeberg, Snohomish, WA (US)

(73) Assignee: RING & PINION SERVICE, INC., Everett, WA (US)

(21) Appl. No.: 13/423,933

(22) Filed: Mar. 19, 2012

Related U.S. Application Data
(60) Provisional application No. 61/454,880, filed on Mar. 21, 2011.

(51) Int. Cl. F16H 48/24

(52) U.S. Cl. 475/233

(57) ABSTRACT

A locking differential having a movable locking ring that can selectively engage a gear of the differential to lock or unlock the differential is disclosed. The locking ring is moved by a pressure source, such as a pneumatic pressure source, and a spring. The locking ring engages a fixed annular ring in the case of the differential. Two O-rings create a seal between sides of the fixed annular ring and arms of the locking differential.

### PRIORITY CLAIM

This application claims the benefit of U.S. provisional application No. 61/454,880, filed Mar. 21, 2011.

### FIELD OF THE INVENTION

The present invention relates generally to a selectively lockable differential having a locking ring that engages a gear of the differential to lock the differential.

### BACKGROUND OF THE INVENTION

Automotive differentials are useful in transferring the rotational force from a driveshaft to the driving wheels of the vehicle. In automobiles and other vehicles, the differential allows the right and left wheels of the vehicle to rotate at different rates. When a vehicle turns, the outer wheels have a greater distance to travel due to the larger radius of the turn. Differentials allow this to happen without skidding, slipping, or over-running either of the wheels. While this differential action is desirable in many driving conditions, it may sacrifice torque or traction in some environments and is therefore less desirable in those cases. For example, off-road vehicles may benefit more from the increased traction, making it worthwhile to accept some degree of slippage during turns. Since many vehicles are not used exclusively on-road or off-road, it is desirable to be able to selectively lock a differential.

Conventional locking differentials, such as that shown in U.S. Pat. No. 5,591,098, lock and unlock the differential gears by moving a locking ring into and out of engagement with a side gear. The locking ring is moved back and forth through force applied by air pressure and a return spring. This design, however, is relatively bulky and provides less engagement between the side gear and the locking ring than may be desired. The locking ring also includes internal and external splines or teeth and other aspects that complicate the design or make it less than desirable.

With respect to the design shown in U.S. Pat. No. 5,591,098, it is known to construct a locking differential having a movable locking ring using an air cylinder and a return spring. While this patent only shows a configuration in which the cylinder is formed within the housing to provide an air chamber that may be pressurized to push the locking ring in a first direction, with a return spring urging the locking ring in the opposite direction, it would be understood that reversing the orientation of the cylinder and return spring produces an equivalent design. Nonetheless, merely reversing the positions of the air chamber and return spring does not overcome some of the other defects in the design. For example, the air chamber and seal arrangement of U.S. Pat. No. 5,591,098 is less than ideal and serves to limit the travel distance of the locking ring. In addition, the inclusion of interior and exterior splines or teeth on the lock ring are less than desirable, and the overall design leads to a short distance of travel for the locking ring, further contributing to these concerns. Thus, while this arrangement does produce a selectively lockable differential, the particular implementation also includes certain shortcomings.

### SUMMARY OF THE INVENTION

The present invention is generally directed to a differential comprising a housing (sometimes referred to as a carrier or case) having internal gears configured for differential action. A locking ring is positioned to be selectively moved into engagement with one or more of the gears, thereby either allowing differential rotation or preventing it.

In a preferred version of the invention, the locking ring is formed with a central channel forming a sealed chamber to facilitate air driven movement into the locked or unlocked position. A return spring is positioned on a side of the locking ring opposite the channel to urge the locking ring in a direction opposing the force applied by the compressed air.

In accordance with a preferred version of the invention, the housing is configured to support pair of half axles having a major axis. The differential also includes a number of pinion gears, a first side gear meshed with the pinion gears, and a second side gear meshed with the pinion gears. The differential also includes a locking ring having a base, an inner arm, and an outer arm. The locking ring is supported by the first case and selectively engages with the first side gear. When the locking ring is engaged with the first side gear the differential is locked, and when the locking ring is disengaged from the first side gear the differential is unlocked. The differential also includes a fixed annular ring having an inner side, an outer side, a base, and a distal end. The locking ring is sealed to the fixed annular ring by an inner seal positioned between the inner side of the fixed annular ring and the inner arm of the locking ring and an outer seal positioned between the outer side of the fixed annular ring and the outer arm of the locking ring. The base, the inner arm, and the outer arm of the locking ring form a chamber with the inner and outer seals and the distal end of the fixed annular ring. The differential further includes a pressure source operably coupled to the chamber and configured to exert pressure on the locking ring to move the locking ring along the major axis and into engagement with the first side gear. The differential can have a biasing member coupled to the locking spring to oppose motion of the locking ring and to bias the locking ring out of engagement with the first side gear.

In other embodiments, the present invention is directed to a retrofit kit for a differential comprising a first side gear, a second side gear, a number of pinion gears engaged with the first and second side gears, a first case, and a second case. The first and second case support the first and second side gears and the pinion gears and an axle having a major axis. The retrofit kit comprises a replacement case configured to engage with the second case in place of the first case, a fixed annular ring extending from the replacement case and having an inner surface and an outer surface substantially parallel with the major axis, and a locking ring having a base, an inner arm, and an outer arm. The locking ring is positioned with the inner arm adjacent to the inner surface of the fixed annular ring and with the outer arm adjacent to the outer surface of the fixed annular ring. The retrofit kit also includes a first seal positioned between the inner arm of the locking ring and the inner surface of the fixed annular ring, and a second seal positioned between the outer arm of the locking ring and the outer surface of the fixed annular ring. The base, the inner arm, and the outer arm of the locking ring form a pressure chamber with the distal end of the fixed annular ring and the first and second seals. The retrofit kit also includes a pressure source configured to apply pressure within the pressure chamber to move the locking ring into engagement with the first side gear to lock the differential, and a return spring positioned between the locking ring and the second case to bias the locking ring out of engagement with the first side gear.

### BRIEF DESCRIPTION OF THE DRAWINGS

Preferred and alternative examples of the present invention are described in detail below with reference to the following drawings.

FIG. 1 is an exploded view of a locking differential according to preferred embodiments of the present invention.

FIG. 2A is an assembled cross sectional view of the locking differential assembly of FIG. 1, shown in the locked position according to preferred embodiments of the present disclosure.

FIG. 2B is a detail view of a cross section of the locking differential of FIG. 2A according to preferred embodiments of the present invention.

FIG. 3 is a plan view of a locking ring of the locking differential according to preferred embodiments of the present invention.

FIG. 4 is a perspective view of a preferred housing cover for use with a preferred locking differential.

### DETAILED DESCRIPTION OF THE PREFERRED EMBODIMENT

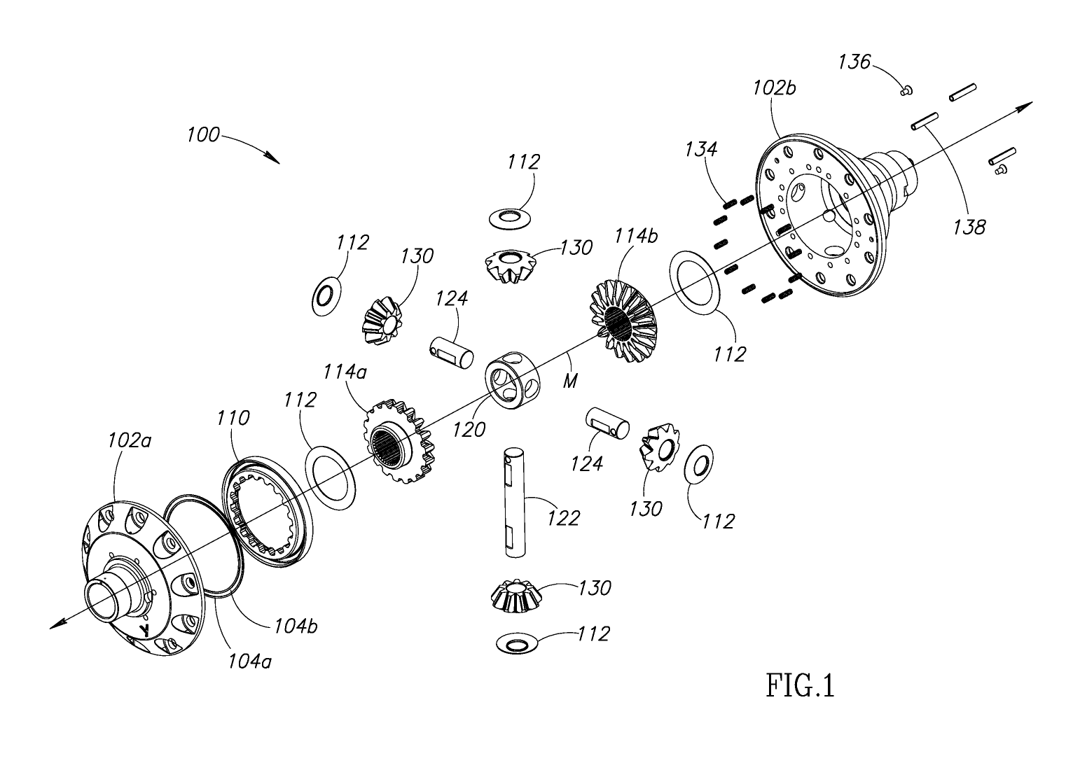

FIG. 1 is an exploded view of a locking differential assembly 100 according to preferred aspects of the present invention. The assembly 100 includes a main housing 102a and a housing cover 102b that support and house components of the assembly 100. Half axles are preferably splined to bevel gears, or side gears, for rotation along a major axis M. In general, the cover and housing may be referred to collectively as the housing or carrier. The differential assembly 100 includes a first side gear 114a and a second side gear 114b opposite the first side gear 114a. The side gears rotate about the major axis.

The assembly 100 also includes a number of pinion gears 130 (four shown in the example of FIG. 1, but either more or fewer may be used) arranged to mesh with the first and second side gears 114a, 114b. Each pinion gear 130 is engaged with both the first and second side gears 114a, 114b.

The assembly 100 can also include a spider block 120, a long cross shaft 122 and a short cross shaft 124 upon which the pinion gears 130 rotate, several washers 112, and various fasteners such as screws 136 and a retaining pin 138. The assembly 100 also includes a first seal ring 104a and a second seal ring 104b, and a locking ring 110 that can be selectively moved into and out of engagement with the first side gear 114a. The seals 104a, 104b can be O-rings or another equivalent seal.

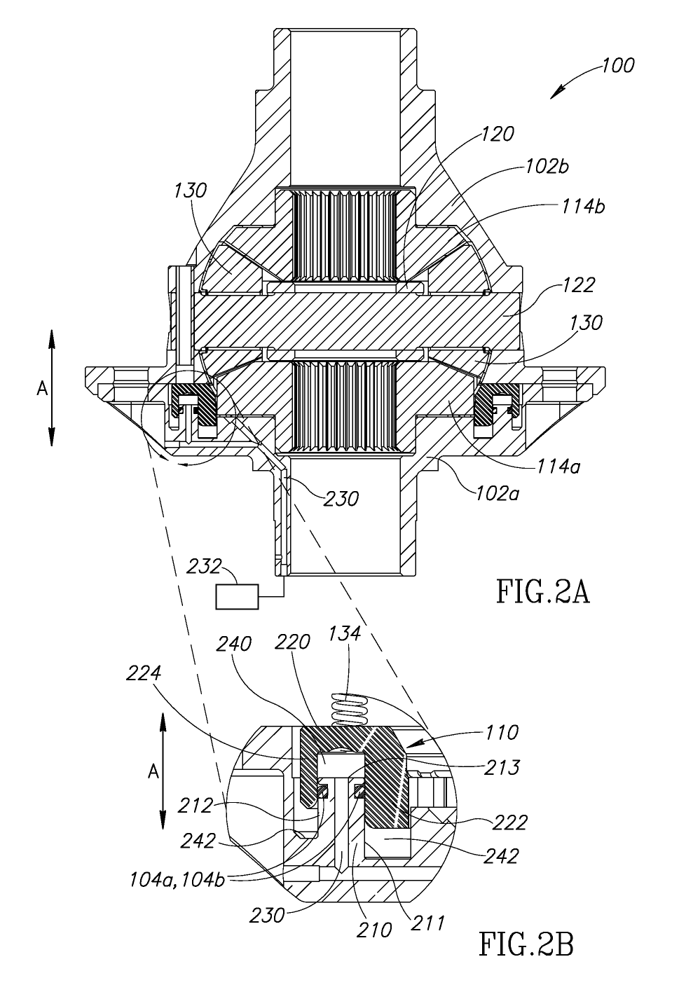

FIG. 2A is an assembled cross sectional view of the differential assembly 100 of FIG. 1 according to preferred aspects of the present disclosure, shown in the locked position. Elements of the assembly 100 shown in FIG. 1 are shown here in an assembled state with similar reference numerals. FIG. 2B is a detail view of a cross section of the locking differential of FIG. 2A. The housing 102a can include a fixed annular ring 210 or post extending from the case and generally toward the second case in a direction parallel with the major axis of the assembly 100. The fixed annular ring 210 has an inner side 211 and an outer side 212. The inner surface of the inner side 211 is concave as the fixed annular ring is a revolved section generally concentric with the major axis. Similarly, the outer surface of the outer side 212 is a convex surface. The fixed annular ring 210 has a distal end 213.

The locking ring 110 has a base 220, an inner arm 222, and an outer arm 224 forming an annular channel within the annular locking ring. The locking ring 110 therefore has a generally U-shaped cross section. The interior of the U-shape engages the fixed annular ring 210 (which in the sectional view of FIGS. 2A and 2B appears in the form of a vertical post). In particular, the inner side 211 of the fixed annular ring 210 is positioned against the inner arm 222, and the outer side of the fixed annular ring 212 is positioned against the outer arm 224.

The assembly 100 also includes a first seal 104a and a second seal 104b. In some embodiments the first seal 104a is an inner seal positioned between the inner side 211 and the inner arm 222, and the second seal 104b is an outer seal positioned between the outer side 212 and the outer arm 224. As best seen in FIG. 2B, the first seal 104a and second seal 104b are each received and retained within channels formed in the annular ring 210.

The base 220, the inner arm 222, and the outer arm 224 of the locking ring 110 form a chamber 240 with the distal end 213 of the fixed annular ring 210, the first seal 104a, and the second seal 104b. Most preferably, this seal is airtight. As noted above, most preferably the fixed annular ring 210 includes recesses in the first side 211 and second side 212 in which the first seal 104a and second seal 104b sit. The first and second seals 104a, 104b are therefore frictionally fixed relative to the fixed annular ring 210, but may alternatively be retained by other means such as molding, gluing, or other suitable means.

The fixed annular ring 210 includes an air passage 230 operably coupled to a pressure source 232. In some embodiments, the pressure source 232 comprises a pneumatic or hydraulic pressure source such as a canister of compressed air. In still other embodiments, the pressure source 232 can comprise a mechanical actuator such as a solenoid configured to mechanically move the locking ring 110 along the major axis as shown by the arrows A.

The pressure source 232 can be operably coupled to a controller (not shown) that can receive an instruction to lock or unlock the differential assembly 100. The instruction can be an automatic instruction triggered by sensing certain road conditions that are more suited to a locked or an unlocked differential. In other embodiments, the instruction is received in from a user. When the differential assembly 100 is to be locked, the pressure source 232 fills the chamber 240 with pressurized gas, which exerts pressure on the locking ring 110 and thereby causes the locking ring 110 to move upward in the illustration of FIG. 2B. In this locked position, there is a gap 242 between the cover or housing and the distal end of the inner arm 222. At the same time, this movement compresses the return spring 134. The movement of the locking ring outward, away from the annular ring 210, is a movement toward a position in which it engages the first side gear 114a to lock the differential. The seals 104a, 104b ensure that the pressure causes the locking ring 110 to move. As noted above, the assembly 100 can also include a return spring 134 to bias the locking ring 110 in a disengaged position. When the pressure source 232 releases the pressure the spring 134 moves the locking ring 110 out of engagement with the first side gear 114a. In the unlocked position, there is little or substantially no gap 242 present as the distal end of the inner arm 222 is moved downward, toward the cover.

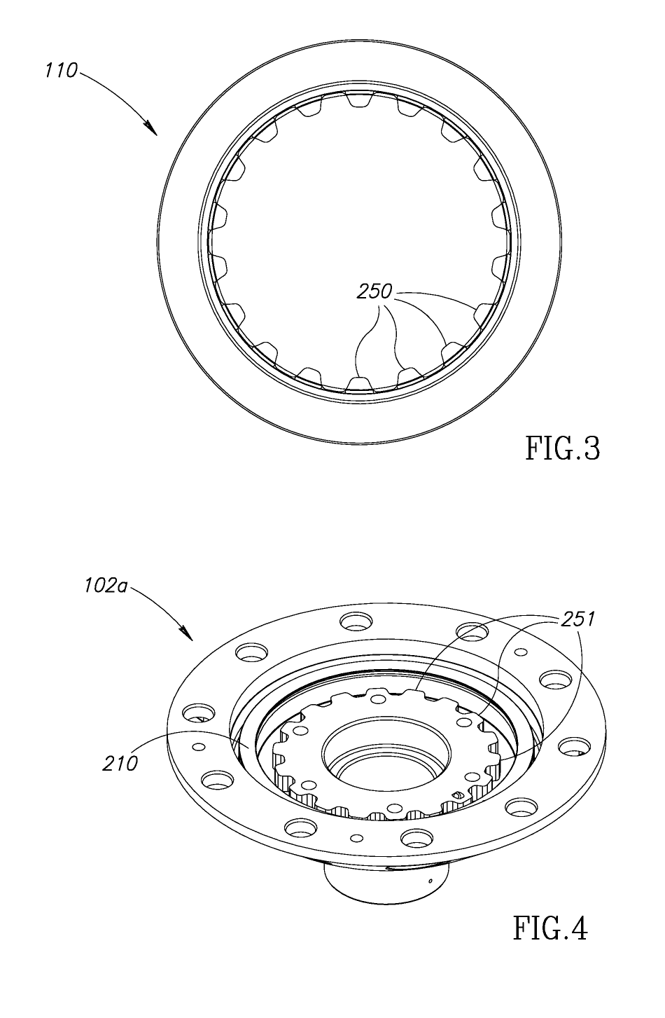

FIG. 3 is a plan view of a locking ring 110 according to embodiments of the present invention. The locking ring 110 has gear teeth 250 extending inward from the ring 110 and configured to engage corresponding teeth of the first side gear 114a. The gear teeth 250 of the locking ring 110 can be involute gear teeth similar to teeth of the side gear 114a. In other embodiments, the locking ring 110 can lock the differential by another mechanical structure that interferes with movement of the side gear 114a. For example the side gear 114a can have a slot and the locking ring 110 can have a peg that fits within the slot. Any other suitable mechanical equivalent can be used to lock the differential.

FIG. 4 is a perspective view of the cover 102a. As shown, the cover includes a fixed annular ring 210, as described above. At a location within the fixed annular ring, the cover includes an internal hub having a plurality of teeth 251 formed about a periphery of the hub. When the locking ring is assembled in position as shown in FIGS. 2A and 2B (shown in the locked position), the channel formed in the U-shaped locking ring engages the annular ring 210. In addition, the inward gear teeth 250 of the locking ring are enmeshed with the peripheral teeth 251 formed on the central hub within the cover and with the teeth on the side gear 114a. The engagement of the locking ring teeth 250 and cover teeth 251 ensure that the locking ring is fixed in rotational position within the housing. The particular design as disclosed provides a plurality of teeth extending continuously about the interior of the locking ring, thereby providing a strong interface between the cover and the locking ring.

As the locking ring is moved into the locking position (that is, when the chamber 240 is filled with pressurized air, moving the locking ring away from the annular ring 210), the inner teeth 250 of the locking ring engage external teeth on the side gear 114a. The positioning of the teeth on these respective components is also seen in the exploded view of FIG. 1. With the teeth of the locking ring and side gear enmeshed, the gears above are fixed in position and differential movement is not allowed. The release of gas from the chamber 240 causes the return spring 134 to push the locking ring in the opposite direction, separating its teeth from the teeth of the side gear, thereby allowing differential rotation once again.

The configuration of the seals 104a, 104b on the sides 211, 212 of the fixed annular ring 210 enable a large travel distance for the locking ring 110, which in turn enables a high amount of engagement between the locking ring 110 and the first side gear 114a. In some embodiments, the distal end 213 of the fixed annular ring 210 and the base 220 of the locking ring 110 can be spaced apart by at least approximately 3.5 millimeters. The engagement between the locking ring 110 and the first side gear 114a can therefore also be approximately 3.5 millimeters. Thus, the larger degree of travel allows for both a larger surface area of gear engagement in the locking position as well as a larger distance of clearance between the teeth in the unlocked position.

As illustrated and described above, the locking ring includes a single set if teeth formed on the interior side of the annular ring. The configuration as illustrated allows teeth to be placed only on the interior, thereby using the same teeth 250 to engage the side gear 114a and to engage the cover teeth 251. This produces a simpler design than prior art locking rings, which require interior teeth and external teeth or splines to lock the ring to the cover. At the same time, the locking ring provides a stronger bite and greater clearance, as described above.

The configuration of the present disclosure also permits the assembly 100 to be implemented as a retrofit kit for an existing differential. In some embodiments, the first case 102a, the locking ring 110, the air passage 230 and the pressure source 232 can be installed into an existing, non-locking differential in place of a case similar to the first case 102a that does not have these components or the ability to lock the differential. Some differential designs that use an air pressure mechanism to move a locking ring, the air pressure mechanism is found in the second case. However, the second case supports the shafts for the pinion gears and the greater portion of the assembly and, accordingly, is not readily interchangeable without disassembling more significant portions of the assembly.

In an alternate version of the invention, the locking ring may include locking ring teeth formed on a radially outward portion of the locking ring, rather than radially inward. Thus, in such a version the locking ring teeth may be formed on the outer arm 224 and extend radially outward. In addition, the cover for such a version will include teeth that are positioned and configured to engage the locking ring teeth. Thus, the cover will include a raised projection having teeth portion having teeth radiating inward and positioned to mesh with the locking ring teeth 250 formed on the locking ring.

While the preferred embodiment of the invention has been illustrated and described, as noted above, many changes can be made without departing from the spirit and scope of the invention. For example, the pressure source can be any suitable pressure source, including pneumatic or hydraulic pressure. Or the locking ring can be actuated by mechanical means such as by a solenoid or equivalent mechanical means. Accordingly, the scope of the invention is not limited by the disclosure of the preferred embodiment. Instead, the invention should be determined entirely by reference to the claims that follow.

1. A differential, comprising:
a differential housing including a cover, the housing supporting a first side gear, a second side gear, and at least one pinion gear enmeshed with the first side gear and the second side gear;
the cover having an interior side, the interior side including a raised central hub having a plurality of peripheral cover teeth, the interior side of the cover further having a raised annular ring surrounding the central hub;
an annular locking ring having an annular channel formed within the annular locking ring, the annular channel receiving the annular ring formed in the cover to define a chamber between the annular ring and the annular channel, the annular locking ring further having a plurality of locking ring teeth extending radially inward from the annular locking ring, the plurality of locking ring teeth being enmeshed with the plurality of cover teeth;
the first side gear having a plurality of first side gear teeth, the plurality of first side gear teeth being sized and arranged for selective engagement with the plurality of locking ring teeth;
a pressure source operably coupled to the chamber and configured to force a fluid into the chamber, wherein the fluid urges the locking ring in an outward direction, away from the annular ring and the cover; and
a biasing member coupled to the locking ring to bias the locking ring in an inward direction, toward the annular ring and the cover;
whereby when the pressurized fluid is forced into the chamber the locking ring moves outward from the cover and the plurality of locking ring teeth are engaged with both the cover teeth and the first side gear teeth, and when the pressurized fluid is released from the chamber the locking ring moves inward toward the cover and the plurality of locking ring teeth are not engaged with the first side gear teeth.

2. The differential of claim 1 wherein the annular ring further comprises an inner side, an outer side, and a distal end, the annular ring further comprising a first seal positioned on the inner side and a second seal positioned on the outer side.

3. The differential of claim 2 wherein the annular ring further comprises a first recess formed on the inner side and a second recess formed on the outer side, the first seal being retained within the first recess and the second seal being retained within the second recess.

4. The differential of claim 3 wherein the inner and outer seals comprise O-rings.

5. The differential of claim 1 wherein the biasing member comprises a spring.

6. The differential of claim 1 wherein the pressurized fluid comprises pressurized air.

7. The differential of claim 1, wherein the annular ring further comprises a fluid passageway extending through the annular ring and into the chamber, wherein the pressurized fluid is configured to pass through the fluid passageway.

8. The differential of claim 1 wherein the central hub and annular ring are integrally formed in the cover.

9. A differential, comprising:
a differential housing including a cover, the housing supporting a first side gear, a second side gear, and at least one pinion gear enmeshed with the first side gear and the second side gear;
the cover having an interior side, the interior side having a raised post;
a locking ring having a channel formed within the locking ring, the channel receiving the raised post formed in the cover to define a chamber between the raised post and the channel, the locking ring further having a plurality of locking ring teeth extending from the locking ring, the locking ring and cover further having a means for retaining the locking ring in a fixed rotational position with respect to the cover;
the raised post further having an inner side, an outer side, and a distal end, with a first seal positioned on the inner side and a second seal positioned on the outer side, the seals cooperating to form an airtight seal for the chamber;
the first side gear having a plurality of first side gear teeth, the plurality of first side gear teeth being sized and arranged for selective engagement with the plurality of locking ring teeth;
a pressure source operably coupled to the chamber and configured to force a fluid into the chamber, wherein the fluid urges the locking ring in an outward direction, away from the raised post and the cover; and
a biasing member coupled to the locking ring to bias the locking ring in an inward direction, toward the raised post and the cover;
whereby when the pressurized fluid is forced into the chamber the locking ring moves outward from the cover and the plurality of locking ring teeth are engaged with the first side gear teeth, and when the pressurized fluid is released from the chamber the locking ring moves inward toward the cover and the plurality of locking ring teeth are not engaged with the first side gear teeth.

10. The differential of claim 9 wherein the raised post further comprises a first recess formed on the inner side and a second recess formed on the outer side, the first seal being retained within the first recess and the second seal being retained within the second recess.

11. The differential of claim 9 wherein the biasing member comprises a spring.

12. The differential of claim 9 wherein the pressurized fluid comprises pressurized air.

13. The differential of claim 9, wherein the raised post further comprises a fluid passageway extending through the raised post and into the chamber, wherein the pressurized fluid is configured to pass through the fluid passageway.

14. A kit for conversion of a locking differential, comprising:
a housing cover configured for attachment to a differential housing, the cover having an interior side, the interior side including a raised central hub having a plurality of peripheral cover teeth, the interior side of the cover further having a raised post radially outward from the central hub;
an annular locking ring having a channel formed within the annular locking ring, the channel receiving the raised post formed in the cover to define a chamber between the annular ring and the channel, the annular locking ring further having a plurality of locking ring teeth extending radially inward from the annular locking ring, the plurality of locking ring teeth being enmeshed with the plurality of cover teeth;
the first side gear having a plurality of first side gear teeth, the plurality of first side gear teeth being sized and arranged for selective engagement with the plurality of locking ring teeth;
a pressure source operably coupled to the chamber and configured to force a fluid into the chamber, wherein the fluid urges the locking ring in an outward direction, away from the raised post and the cover; and
a biasing member coupled to the locking ring to bias the locking ring in an inward direction, toward the raised post and the cover;
whereby when the pressurized fluid is forced into the chamber the locking ring moves outward from the cover and the plurality of locking ring teeth are engaged with both the cover teeth and the first side gear teeth, and when the pressurized fluid is released from the chamber the locking ring moves inward toward the cover and the plurality of locking ring teeth are not engaged with the first side gear teeth
